(19) United States
(12) Patent Application Publication
(10) Pub. No.: US 2024/0164426 A1
(43) Pub. Date: May 23, 2024

(54) AN APPARATUS FOR STEAMING ANIMAL FODDER

(71) Applicant: SANDERSON PLASTIC PRODUCTS LTD., Alresford Hampshire (GB)

(72) Inventors: Rob SANDERSON, Alresford Hampshire (GB); Andrew SANDERSON, Alresford Hampshire (GB); Austen MILLER, Whitchurch Hampshire (GB); Daniel PHILLIPS, Whitchurch Hampshire (GB)

(21) Appl. No.: 18/283,442

(22) PCT Filed: Mar. 21, 2023
(86) PCT No.: PCT/EP2022/057336

§ 371 Date: Sep. 21, 2023

(30) Foreign Application Priority Data
Mar. 23, 2021 (GB) 2104025.8

(51) Int. Cl. A23N 17/00; A23K 30/10

(52) U.S. Cl. CPC A23N 17/004; A23K 30/10

(57) ABSTRACT

The present invention provides an apparatus for steaming animal fodder comprising a body defining a chamber in which the animal fodder may be placed. The body comprises an upper part and a lower part configured to be placed together to form the chamber. The apparatus further comprises a conduit configured to carry steam to an aperture configured to allow the steam to pass into the chamber. The body is formed from an expanded polymer foam.

### FIELD OF INVENTION

The present invention relates to an apparatus for steaming animal fodder, in particular hay. More particularly, the present invention relates to an apparatus for steaming hay that reduces bacteria, mould spores, fungi and dust particles in the hay.

### BACKGROUND

Hay, and other types of fodder such as straw, silage and haylage, are commonly fed to horses, as well as other livestock, and may be used for growing plants, fruit and vegetables such as mushrooms. However, such fodder may contain many different types of bacteria, mould spores and dust particles that can affect a horse's breathing and cause coughing. The particles are respiratory irritants, and can lead to respiratory diseases such as chronic obstructive pulmonary disease (COPD).

It is well known to soak hay with water to mitigate respiratory issues in horses and other livestock. Soaking the hay causes the particles to stick to the hay, so they are consumed, rather than inhaled. However, soaking reduces the sugar content in the hay and can also result in loss of nutrients. Soaked hay is also significantly heavier due to the increased water content, making it harder to carry. If left for too long, the soaked hay can spoil as bacteria builds up, since soaking does not kill the particles.

Some of these disadvantages may be overcome by using a hay steamer to treat hay bales with steam in order to remove and kill the bacteria, mould spores, fungi and dust particles. Steaming the hay or other silage reduces the risk of causing and/or exasperating allergies and respiratory issues. The advantages of using a steamer over soaking hay include increased removal of the particles, less nutrient loss, more palatable hay, and increased water intake by a horse, improving their hydration. In addition, significantly less water is needed for steaming compared to soaking.

An example of a hay steamer is to be found in patent publication GB 2,454,969. The body of the hay steamer comprises four side walls that rise from a base to form a chamber into which hay bales may be loaded. The top of the steamer comprises a hinged lid that may be opened to allow loading and unloading of hay bales, and closed to form a closed chamber when the hay bales are being steamed. A separate boiler unit heats water to produce steam. The boiler unit is connected to the body of the hay steamer via a hose which, in turn, connects to further hoses and then to lances that extend into the chamber and penetrate any bale loaded in the chamber. In this way, steam generated by the boiler unit travels to and through the body of the hay steamer, and then passes through at least one steam distribution manifold and into the lances from where the steam is injected into the hay bale through apertures in the lances. The hot steam rises through the hay bale, treating the hay bale as it does so. Typically, the bale is exposed to a continuous supply of steam for approximately 40 minutes, heating the bale to between 70° C. and 100° C. When steaming is complete, the hay steamer must be switched off manually to avoid the boiler running dry and potentially causing damage to the steamer.

The hay steamer suffers from further disadvantages. To load the steamer, a user must lift a heavy hay bale high to clear the tall side walls before leaning forward and lowering the hay bale into the chamber. This puts considerable physical strain on the user. The problem is exacerbated when unloading, as the steamed bale is heavier due to increased water content. Furthermore, steamers are frequently moved around which is not easy due to the heavy weight of the steamer.

There is therefore a need to provide an improved hay steamer.

### SUMMARY

In a first aspect, there is an apparatus for steaming animal fodder, for example a hay steamer configured to steam hay bales. The apparatus comprises a body defining a chamber in which the animal fodder may be placed. The chamber may have a size of at least 100 cm×40 cm×30 cm so as to fit a standard-sized hay bale.

The body comprises an upper part and a lower part configured to be placed together to form the chamber. The apparatus further comprises a conduit configured to carry steam to an aperture configured to allow the steam to pass into the chamber. The body is formed from an expanded polymer foam.

The use of expanded polymer foam to form the body of the apparatus has been found to offer significant advantages over traditional constructions such as double-skinned walls, where each wall is solid and is separated by an insulating air gap. Expanded polymer foam has a very high strength-to-weight ratio, which allows a substantial reduction in the weight of the apparatus when compared to known hay steamers, whilst still maintaining the required structural strength. The reduced weight makes the apparatus much easier to move around. Furthermore, air spaces in the expanded polymer foam provide the apparatus with the required thermal insulating properties that ensures the animal fodder may be effectively steamed at a high temperature in an energy-efficient manner.

The expanded polymer foam may be an expanded polypropylene foam or an expanded polystyrene foam. The expanded polymer foam may have a density of 50-80 kg/m³. These densities provide excellent weight-to-strength ratios and excellent insulation. The base, the top and the walls may have a thickness of 60 mm. This is particularly advantageous when used with expanded polypropylene foam or an expanded polystyrene foam having a density of 50-80 kg/m³ as it provides good strength and insulation, without being too heavy.

The body defining the chamber may comprise a base provided by the lower part, a top provided by the upper part and walls provided by the lower part and/or the upper part. The base, the top and the walls are formed of the expanded polymer foam.

The expanded polymer foam of the base, the top and the walls may be structural. This is in contrast to arrangements where the foam may be used just for insulation, for example foam placed within a double-skinned wall where it would be the double skins that provide structural support. Advantageously, this means that the base, the top and the walls require no further support: the expanded polymer foam provides both the structural support and the insulation required.

While the upper part and the lower part may be assembled from individual pieces of expanded polymer foam, the upper part and the lower part may both be unitary structures consisting of the expanded polymer foam.

The upper part and the lower part may be joined by hinges that allow the upper part to be opened to provide access to the chamber. The upper part and the lower part may also comprise knuckles of the hinges formed from the expanded polymer foam. Conveniently, they may be formed as part of a unitary structure for each of the upper part and the lower part.

Steam may be provided by a separate component to the apparatus, and provided to the apparatus via a connection to an inlet. However, in currently-contemplated embodiments, the apparatus comprises an integrated boiler operable to boil water to generate the steam. The apparatus may further comprise a pump operable to pump water to the boiler, and a controller operable to control operation of the apparatus. The controller may be suitably-programmed computer, or a suitably design electronic circuit. The boiler, the pump and the controller may each be mounted to a tray. The tray may, in turn, be mounted to the body of the apparatus using screws. Mounting to an expanded polymer foam requires care, so mounting other components to a tray, such as a plastic tray, may be easier. Then, just the larger tray may be connected to the expanded polymer foam of the body. For example, the screws may be configured to work with the expanded polymer foam by having a deep thread and/or a thread with a shallow pitch. Such screws are sometimes referred to as self-drilling wall anchors. The threads of such screws provide a greater area of contact with the expanded polymer foam, thereby providing a more secure connection. Conveniently, the tray may mount in a recess provided in the underside of the lower part. By mounting the tray in the recess provided in the underside of the lower part, the apparatus can be self-contained and provides a smaller footprint. Furthermore, the components attached to the tray are better protected from knocks and the like by being located in the recess. A sump guard may be provided to cover the recess. This provides further protection to the components.

The chamber may be accessed from the front of the apparatus in an easier manner by forming the front wall as part of the upper part. This means that the front wall is moved out of the way when the apparatus is opened, making it easier to load animal fodder into the apparatus. In addition, the lower part comprises a floor configured to receive the animal fodder and the floor may extend fully to the front of the apparatus. The floor of the lower part may be absent a lip at the front of the apparatus, thereby providing unimpeded access to the chamber. Advantageously, this configuration provides easy access to the chamber through a large aperture defined by the lower part. The absence of a lip at the front of the apparatus makes it much easier to load and unload fodder such as bales into the apparatus compared to the prior art steamers. The animal fodder does not need to be lifted up and over a high front wall. In contrast, the absence of the front wall and any lip means that bales need only be raised a small height before being placed on the floor. The bales may then be slid easily into a desired position over the aperture through which steam enters the chamber. Furthermore, the absence of a lip allows water to drain from the chamber. The floor may have a 2° downward slope from back to front to help water drain from the chamber. This is helpful when cleaning the apparatus as it stops dirty water pooling in the chamber.

The walls of the apparatus forming the side walls of the body may be formed by both the upper part and the lower part. In addition, the side walls of the lower part may increase in height from the front to the back, and the side walls of the upper part may decrease in height from the front to the back. This results in the upper part having a relatively high front wall and a relatively low back wall. This results in the upper and lower parts having corresponding wedge shapes such that they close to abut each other and form a general cuboid shape.

As described above, the lower part may comprise a floor configured to receive the animal fodder. The aperture through which steam is introduced into the chamber may be provided in the floor. In addition, the floor may comprise a raised section that forms a frame for supporting a bale of animal fodder. The frame may extend around the aperture such that the frame is supports the bale above the aperture in a spaced apart relationship. Thus, the frame may form a volume beneath the bale that extends above and around the aperture. This arrangement allows some of the steam to spread outwards before entering the bale to effect better steaming. The frame may be of a low height so as to ease loading the bale, for example less than 1 cm. The floor and the frame may be integrally formed in the lower part. This allows all these parts to comprise the expanded polymer foam, and avoids the need for assembly of these parts during manufacture.

Optionally, the frame may be discontinuous to leave a channel for water to drain from the area within the frame surrounding the aperture. Advantageously, the channel allows condensed steam to exit the area during steaming, which prevents the bale from sitting in puddles of water that would otherwise form in the area. In addition, the channel allows water to drain away during cleaning.

The floor may be provided with a series of apertures configured to allow the steam to pass into the chamber. In such arrangement, a single frame may extend around all apertures and may be provided with channels such that water may drain from the area surrounding each aperture. For example, the floor may have three apertures arranged linearly, and the frame may define (exactly or approximately) a square around each aperture, with a channel provided in the frame for each aperture.

In a second aspect, there is an apparatus for steaming animal fodder, for example a hay steamer configured to steam hay bales. The apparatus comprises a body defining a chamber in which the animal fodder may be placed. The chamber may have a size of at least 100 cm×40 cm×30 cm so as to fit a standard-sized bale. The body comprises an upper part and a lower part configured to be placed together to form the chamber. The apparatus further comprises a conduit configured to carry steam to an aperture configured to allow the steam to pass into the chamber. The chamber is accessed from the front of the apparatus and the wall forming the front wall is provided by the upper part. The lower part comprises a floor configured to receive the animal fodder and extends fully to the front of the apparatus.

The floor of the lower part may be absent a lip at the front of the apparatus. Optionally, the walls of the body forming the side walls are formed by both the upper part and the lower part, the side walls of the lower part increase in height from the front to the back, and the side walls of the upper part decrease in height from the front to the back such that the upper part has a relatively high front wall and a relatively low back wall.

Optionally, the aperture is provided in the floor. The floor may comprise a raised section that forms a frame that extends around the aperture such that the frame is adapted to support the bale above the aperture in a spaced apart relationship. The floor and the frame may be integrally formed in the lower part. The frame may be discontinuous to leave a channel for water to drain from the area within the frame surrounding the aperture. The floor may be provided with a series of apertures configured to allow the steam to pass into the chamber. A single frame may extend around all apertures and may be provided with channels such that water may drain from the area surrounding each aperture.

In a third aspect, there is an apparatus for steaming bales of animal fodder, for example a hay steamer configured to steam hay bales. The apparatus comprises a body defining a chamber in which a bale of animal fodder may be placed. The chamber may have a size of at least 100 cm×40 cm×30 cm so as to fit a standard-sized bale. The body comprises an upper part and a lower part configured to be placed together to form the chamber. The apparatus further comprises a conduit configured to carry steam to an aperture configured to allow the steam to pass into the chamber. The lower part comprises a floor configured to receive the bale. The aperture is provided in the floor. The floor comprises a raised section that forms a frame that extends around the aperture such that the frame is adapted to support the bale above the aperture in a spaced apart relationship.

The floor and the frame may be integrally formed in the lower part. The frame may be discontinuous to leave a channel for water to drain from the area within the frame surrounding the aperture. The floor may be provided with a series of apertures configured to allow the steam to pass into the chamber. A single frame may extend around all apertures and may be provided with channels such that water may drain from the area surrounding each aperture.

### LIST OF FIGURES

In order that the invention can be more readily understood, reference will now be made by way of example only, to the accompanying drawings in which:

FIG. 1 is a perspective view of a hay steamer when closed;

FIG. 2 is a perspective view of the hay steamer of FIG. 1, when open;

FIG. 3 corresponds to the view of FIG. 2, but shows the hay steamer loaded with a hay bale;

FIG. 4 is a sectional view of the hay steamer of FIG. 1 loaded with a hay bale;

FIG. 5 is a perspective view of the hay steamer of FIG. 1 stood on its end and showing the underside of the hay steamer;

FIG. 6 corresponds to the perspective view of FIG. 5, but shows the sump guard and water tank removed from the hay steamer; and

FIG. 7 is a detail from FIG. 6.

### DETAILED DESCRIPTION

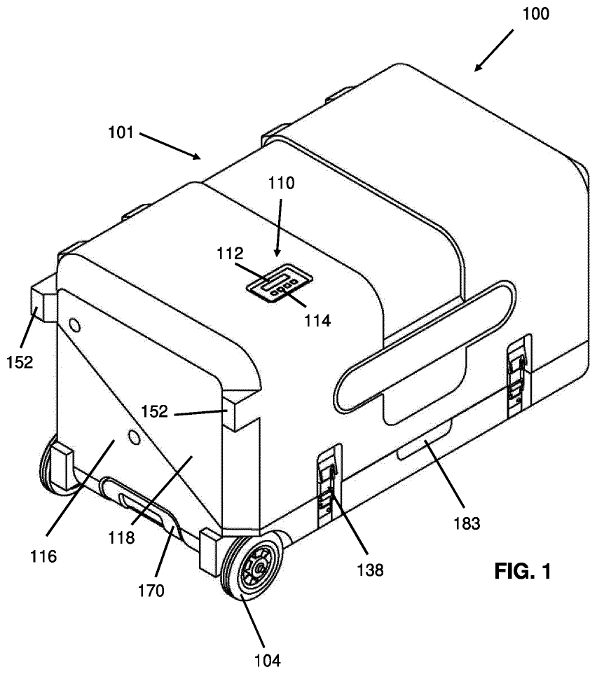

FIG. 1 shows a hay steamer 100 according to an embodiment of the invention.

Although described as a hay steamer 100, it will be understood that the hay steamer 100 is not limited to steaming hay. For example, the hay steamer 100 may be used for steaming other types of animal fodder such as straw, silage and haylage. The hay steamer 100 may also be used for growing plants, fruits and vegetables. For example, the hay steamer 100 may be used to pasteurise straw or other substrate when growing mushrooms.

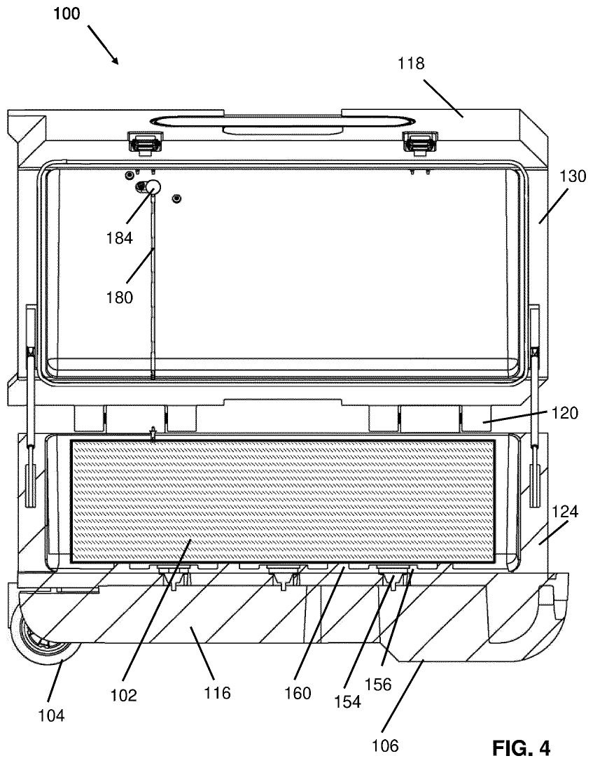

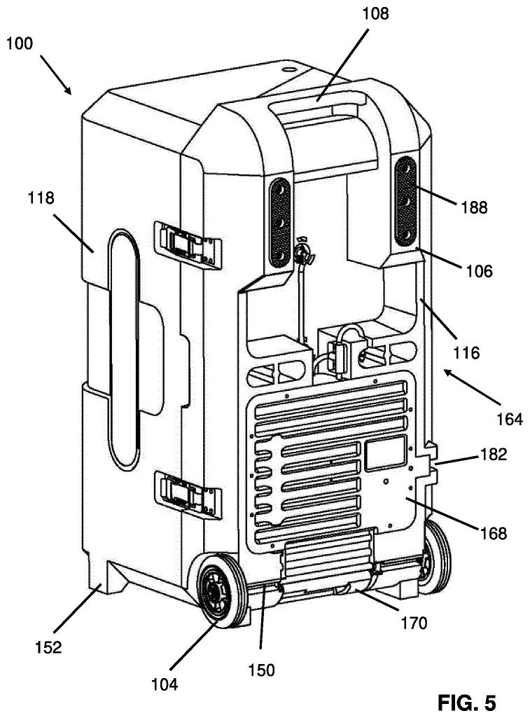

The hay steamer 100 resembles a wheeled-trunk, and has a size suitable for containing a standard-sized hay bale 102. In normal use, the hay steamer 100 rests on a pair of wheels 104 at one end and a pair of feet 106 at the other end (see FIGS. 4 and 5). A handle 108 (see FIG. 5) is provided at the same end as the feet 106. The handle 108 may be used to lift the end of the hay steamer 100 so that the hay steamer 100 may be rolled on its wheels 104 from one location to another. A pair of skid plates 188 are provided on the feet 106. Returning to FIG. 1, the hay steamer 100A is provided with a user interface 110 having a display 112 and control buttons 114.

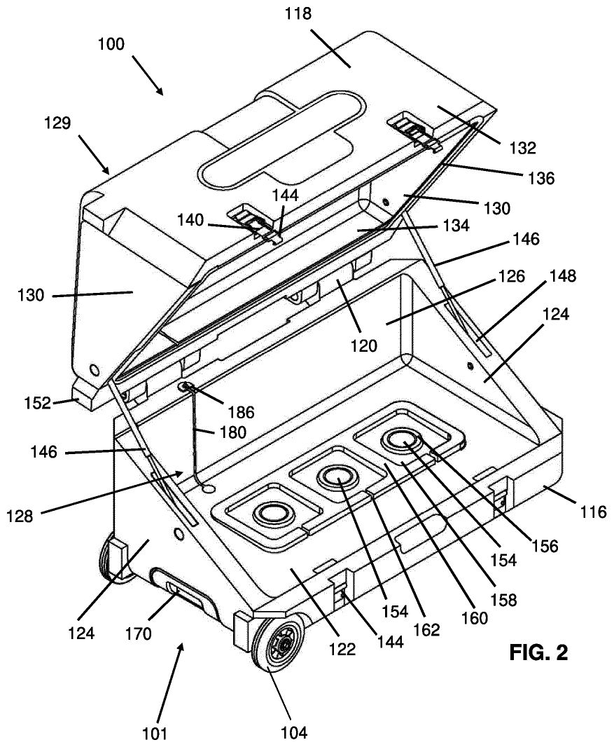

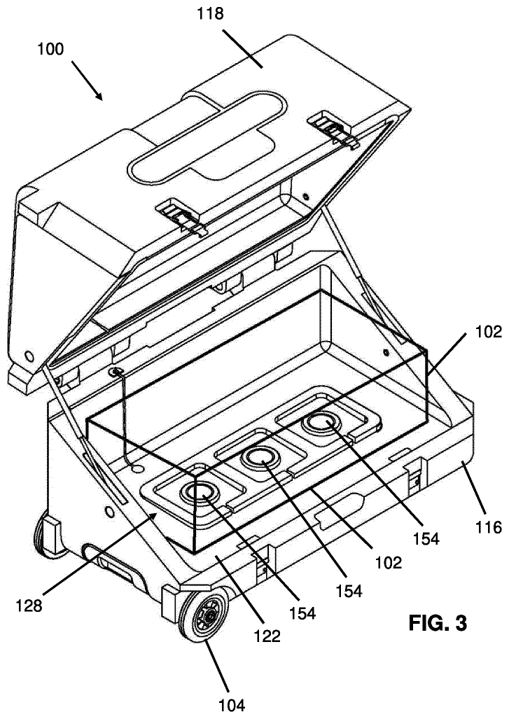

As seen more clearly in FIGS. 2 and 3, the hay steamer 100 has a body 101 comprising a lower part 116 and an upper part 118. Both the lower part 116 and the upper part 118 are generally wedge shaped. The lower part 116 and the upper part 118 are joined by a pair of hinges 120 such that the upper part 118 may be rotated up and clear of the lower part 116 to open the hay steamer 100 and provide access to the hay steamer 100 for loading and unloading a hay bale 102.

The lower part 116 comprises a floor 122 for supporting a hay bale 102, and sloping side walls 124 that join a high back wall 126 of the lower part 116. The lower part 116 has an open front with no lip to the front of the floor 122. This configuration of the lower part 116 provides easy access to the interior 128 of the hay steamer 100 through a large aperture defined by the lower part 116 and the upper part 118 of the hay steamer 100 when opened. In particular, the absence of a front wall or even a lip at the front of the floor 122 makes it much easier to load and unload a hay bale 102 than the prior art hay steamer 100 described above. A further advantage is that the lack of front wall or lip to the floor 122 allows water to drain freely from the hay steamer 100. The floor 122 has a slight slope (e.g.) 2° from back to front to assist further this water drainage.

The upper part 118 has a wedge shape that complements the shape of the lower part 116, with a top wall 129 and sloping side walls 130 that extend from a high front wall 132 to meet a shallow back wall 134. The pair of hinges 120 are provided on the back wall 126 of the lower part 116 and the back wall 134 of the upper part 118. Each hinge 120 comprises alternating knuckles and an interlocking metal pin that passes through the knuckles. In this embodiment, the knuckles are formed integrally with the lower part 116 and the upper part 118. The complementary wedge shapes of the lower part 116 and the upper part 118 means that the lower part 116 and the upper part 118 close to abut each other and form the general trunk shape of the hay steamer 100.

FIGS. 2 and 3 show that the upper part 118 is provided with a resilient seal 136 that extends around the aperture formed by the upper part 118. The seal 136 is retained within a groove (not shown) that extends along lower surfaces of the back wall 134, the side walls 130 and the front wall 132. When the upper part 118 is in the closed position shown in FIG. 1, the seal 136 is seated in a complementary groove (not shown) provided in the upper surfaces of the lower part 116. The seal 136 prevents steam from escaping from the interior 128 of the hay steamer 100 during steaming cycles.

The hay steamer 100 may be secured shut using fasteners 138 provided on the front of the hay steamer 100. In this embodiment, the fasteners 138 comprise a pair of straps 140 that hang from the upper part 118 and that are provided with clasps 142 that hook around catches 144 provided in the lower part 116, as can be seen best from FIGS. 1 and 2. The straps 140 have a cam handle that allows the clasps 142 to be drawn up against the catches 144 into firm engagement. The straps 140 pass through a tri-glide slide (webbing slide) that allows their length to be adjusted, for example to adjust the force required to secure the hay steamer 100 shut and to accommodate any stretching that may occur over time.

The upper part 118 of the hay steamer 100 is held in the open position by gas struts 146 provided on the sides of the hay steamer 100. These gas struts 146 may also assist in moving the upper part 118 to the open position and in allowing the upper art 118 to close gently. The bottom of each gas strut 146 is received within a respective slot 148 provided in one of the side walls 124 of the lower part 116 of the hay steamer 100 where it is pivotably mounted, and the top of each gas strut 146 is pivotably attached to the upper part 118.

The pair of wheels 104 are provided at opposite corners of the left end of the lower part 116 of the hay steamer 100 (when viewed from in front, although the wheels may be provided at the right end), such that the wheels 104 may support the hay steamer 100 when resting both horizontally and vertically. The wheels 104 are connected by an axle 150. A pair of rests 152 project from the left-hand side wall 130 of the upper part 118 above the wheels 104, such that the hay steamer 100 is supported on the wheels 104 and the rests 152 when it is stored vertically (for example, to provide a smaller footprint during storage as shown in FIG. 5).

FIGS. 3 and 4 show the hay steamer 100 with the upper part 118 raised in the open position, and with a hay bale 102 loaded into the interior 128 of the hay steamer 100. As can be seen, the interior 128 of the hay steamer 100 forms a chamber 128 shaped and sized to accommodate a standard-sized hay bale 102. The hay bale 102 rests on the floor 122 of the lower part 116 so as to cover a set of apertures provided in the floor 122 that function as a set of steam vents 154. In this embodiment, three steam vents 154 are equally spaced apart longitudinally, along the centreline of the chamber 128. The steam vents 154 have edges 156 that are slightly raised from the floor 122, see FIGS. 2 and 4. Each steam vent 154 also sits within a compartment 158, and the three compartments 158 are formed by a raised frame 160 provided in the floor 122. The hay bale 102 rests on the frame 160, but not the edges 158 of the steam vents 154 which do not extend so high from the floor 122 (as best seen in FIG. 4). This arrangement allows steam to spread before entering the hay bale 102. Small gaps are provided in the front of the frame 160 to provide channels 162 linking the compartments to the front of the floor 122. This allows condensed steam to exit the compartments 158 during steaming, which prevents the hay bale 102 from sitting in puddles of water that would otherwise form in the compartments 158. The channels 162 also allow water to drain from the compartments 158 when the hay steamer 100 is being cleaned, for example when washing the interior 128 of the hay steamer 100 using a hose.

The frame 160 is of a low height to ease placing hay bales 102 into the hay steamer 100. In particular, the absence of a lip at the front of the floor 122 means that hay bales 102 need be raised only a small height before being placed on the floor 122 and slid into position over the steam vents 154. This may be contrasted to the prior art steamer of GB 2,454,969 where a hay bale 102 must be lifted high to clear a tall front wall before being dropped onto lances extending from the floor 122. Once the hay bale 102 has settled onto the lances, there is little if any opportunity to adjust the position of the hay bale 102. In contrast, FIGS. 2 and 3 herein show that a hay bale 102 need only be placed onto the floor 122 before being slid into position to cover the three steam vents 154. Hence, no precision is required when loading a heavy hay bale 102 into the hay steamer 100, much to the benefit of a user. Unloading a hay bale 102 from the hay steamer 100 of FIGS. 2 and 3 is even easier. The absence of lances and a front wall (or even a lip) at the front of the floor 122 ensures that a hay bale 102 may be simply slid out of the hay steamer 100 without any lifting being required.

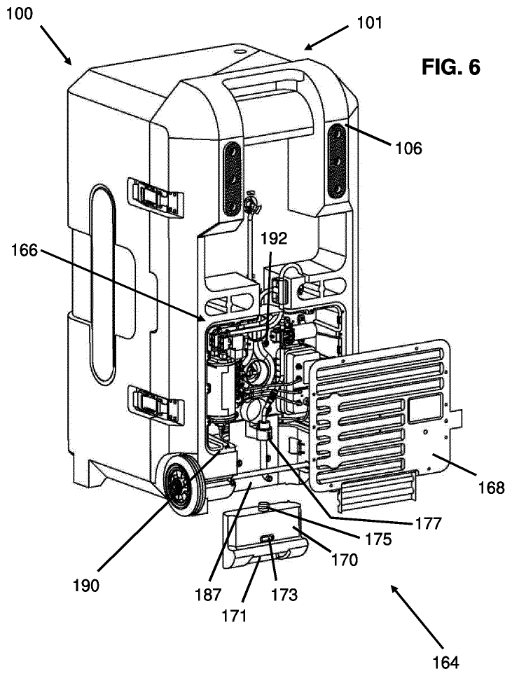

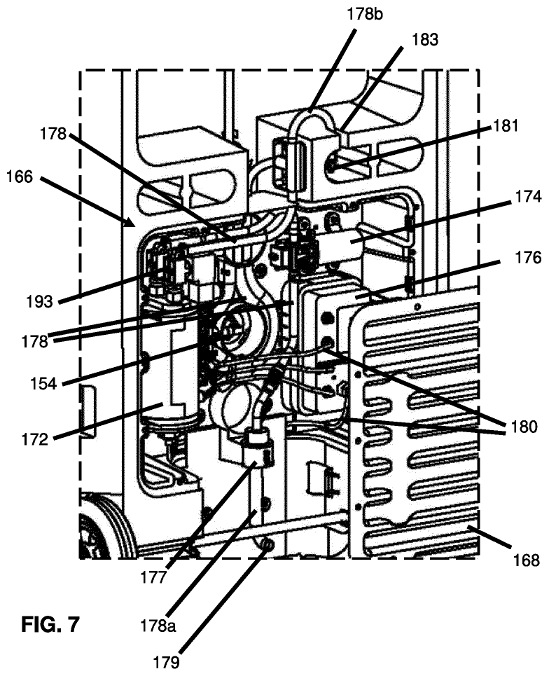

As shown in FIGS. 5 and 6, the underside 164 of the lower part 116 of the hay steamer 100 is provided with a recess 166 covered by the sump guard 168. The recess 166 is used to house a water tank 170, a boiler 172, a pump 174 and a controller 176 (see also the detail of FIG. 7). Hoses 178, 178a, 178b connect the water tank 170 to the pump 174, the pump 174 to the boiler 172, the boiler 172 to the three steam vents 154, and the boiler 172 to a steam vent 181. Wires 180 connect the controller 176 to a power inlet 182 (see FIG. 5), the boiler 172, the pump 174, a thermocouple 184 provided in the chamber 128 (see FIG. 4), a safety switch 186 (See FIG. 2), and to the user interface 110 provided on the upper part 118 of the hay steamer 100.

The water tank 170 is located in a bay 187 formed in the underside 164 of the lower part 116 and is provided with a handle 171 such that the water tank 170 may be easily removed for refilling. In this embodiment the water tank 170 may be filled with up 3.5 litres of water, and then pushed back into the bay 187 where it is positively held in place by an interference fit between a protrusion 173 provided on the underside 164 of the tank 170 and the axle 150 that connects the wheels 104. The tank 170 is provided with a connector 175 (such as a push fit connector) that co-operates with a complementary push fit connection 177 provided at the end of a hose 178a that extends to the boiler 172. A feeder hose 179 also connects to the complementary push fit connection 177, and the feeder hose 179 extends into the water tank 170 through the filling hole provided in the push fit connector 175. The end 179a of the hose 179 is provided with a downward bend such that it draws water from the bottom of the water tank 170. The complementary push fit connection 177 provided on the hose 178a may also be used to provide a direct connection to a hose pipe (not shown) for when a suitable mains water supply is available. The feeder hose 179 is disconnected and a hose pipe provided with the common type of push fit connector may be connected to the hose 178a via the complementary push fit connection 177.

In either arrangement, water from the water tank 170 or the hose pipe flows to the pump 174 via hose 178a, and then onto the boiler 172. Water flow to the boiler 172 is controlled by the controller 176 operating the pump 174 and an inlet valve (not shown). A check valve can be used to prevent water flowing back into the pump 174. Steam created in the boiler 172 flows to the steam vents 154 from three outlets of the boiler 172, from where it passes through the hay bale 102, thereby killing spores and dust particles in the hay bale 102. Steam delivery is controlled by the controller 176 using a valve set 193 located at the outlets of the boiler 172 to the steam vents 154 to allow any or all of the steam vents 154 to be selected.

To steam a hay bale 102, a user will first open the hay steamer 100 by lifting the front of the upper part 118 on its gas struts 146, using a handle 183 provided for this purpose. The upper part 118 is kept open by the gas struts 146, such that the user's hands are free to place the hay bale 102 on the floor 122 of the lower part 116, and to slide the hay bale 102 into position on the frame 160 to cover the steam vents 154.

The user may then close the upper part 118 and secure the straps 140 to seal the chamber 128. The user may check that the water tank 170 contains water or that water is supplied by a hose pipe to the mains connector. However, a warning is provided on the display 112 if the controller 176 detects that the boiler 172 is empty (and operation of the boiler 172 is disabled).

The user can select a steaming cycle by pressing an appropriate start button 114 provided on the user interface 110. This sends a signal to the controller 176 to pump water to the boiler 172, and turn on the boiler 172 to boil the water and create steam. As the steam is produced, the pressure in the boiler 172 is monitored by the controller 176. When the pressure reaches a threshold pressure, the controller 176 operates the valve set to allow steam to flow to one or more of the steam vents 154 and into the hay bale 102.

The hot steam will rise through the hay bale 102, thereby removing and killing the bacteria, mould spores, fungi and dust particles present in the hay bale 102. Steam will rise to the top of the chamber 128, causing the temperature at the top of the chamber 128 to rise steadily. This rising temperature is measured by the thermocouple 184 during the steaming cycle. Once the temperature measured by the thermocouple 184 reaches a threshold temperature, the controller 176 automatically switches off the boiler 172 and pump 174. Advantageously, the automatic switch-off function allows the user to start the hay steamer 100 and then leave without the risk of the boiler 172 boiling dry, therefore avoiding damage to the hay steamer 100. A button 114 on the user interface 110 allows the user to stop steaming at any time, if so desired. At the end of steaming, a flush is performed to relive any pressure remaining in the boiler 172 by opening a valve of the valve set 193 that connects the boiler 172 to the steam vent 181 via hose 178b. The steam vent 181 discharges steam to atmosphere from a safe location on the underside 164 of the hay steamer 100, see FIG. 7. The steam vent 181 may also be used to relieve pressure in the boiler 172 should the boiler 172 and/or controller 176 malfunction and allow too great a pressure to build up in the boiler 172.

To retrieve the treated hay bale 102, the user releases the straps 140 and opens the upper part 118. The treated hay bale 102 may then be easily slid across the floor 122 and out of the hay steamer 100, ready for use. There is also a safety switch 186 positioned on the top of the back wall 126 of the lower part 116 that detects when the hay steamer 100 is open. The safety switch 186 may be any suitable type, such as a mechanical contact switch or a magnetic, electrical or optical sensor. The safety switch 186 is connected to the controller 176 via wires 180. If the safety switch 186 detects that the hay steamer 100 is open, the controller 176 sends a signal to turn off the boiler 172 and/or shut the valve set (not shown) such that no steam can pass through the steam vents 154 and into the chamber 128. This ensures that the steaming cycle can only run when the hay steamer 100 is closed.

As described above, known hay steamers 100 are formed from plastics or metal and typically comprise a body 101 having double-skinned polypropylene walls. Double walls are required to form an insulating cavity between the walls. The double-skinned walls are structural and so must be relatively thick to provide the required structural strength. This results in the hay steamer 100 being heavy and so difficult to move.

In the present invention, the majority of the hay steamer 100 has an alternative construction that produces a hay steamer 100 with a much reduced weight. The body 101 of the hay steamer 100 is formed from an expanded polymer foam. The lower part 116 is produced as an integrated unitary structure of the expanded polymer foam comprising the floor 122, the side walls 124 and the back 126. The upper part 118 is produced as an integrated unitary structure of the expanded polymer foam comprising the top wall 129, the side walls 130, the front wall 132 and the back wall 134.

Examples of expanded polymer foam include expanded polypropylene foam and expanded polystyrene foam, although other suitable types and combinations of expanded foams may also be used. Typically, these expanded foams are used in packaging materials, building insulation and food containers, but it appears that such materials have not been used to form a hay steamer 100. However, it has been realised that the properties of such foams are advantageous for forming the body 101 of the hay steamer 100.

Expanded polypropylene foam and expanded polystyrene foam are closed-cell rigid foams. In this embodiment, expanded foam with a density of 50-80 g/I (50-80 kg/m³) is used to provide the required strength and insulation. The wall thickness of the hay steamer 100 is around 60 mm in this embodiment. This wall thickness may be used in the the floor 122, side walls 124 and back 126 of the lower part 116, and the top wall 129, side walls 130, front wall 132 and the back wall 134 of the upper part 118. The air spaces present in the expanded foam provide excellent thermal insulating properties. Using relatively thick walls in the lower part 116 and the upper part 118 provides a body 101 having the required insulation properties, and also provides the required structural strength. This results in the body 101 of the hay steamer 100 being formed from a material with a very high strength-to-weight ratio, and the body 101 may have a much reduced weight compared to the double-skinned walls used in known hay steamers 100, without sacrificing structural strength. Advantageously, use of the expanded foam provides a significant reduction in the weight of the hay steamer 100 when compared to the steamer of GB 2,454,969, which makes the hay steamer 100 much easier to move around. In addition, the expanded foam has a very low thermal conductivity due to its closed cell structure.

Furthermore, expanded foams like expanded polypropylene foam and expanded polystyrene foam are water- and chemical-resistant. Conveniently, this allows the hay steamer 100 to be stored outdoors without fear of significant deterioration.

Expanded foam is a versatile material and advantageously can be used to form most of the body 101 of the hay steamer 100. For example, in this embodiment, the lower part 116 and the upper part 118 are made of the foam, including the knuckles of the hinges 120, the mounting points for the axle 150 connecting the wheels 104, the mounting points for the straps 140 and the feet 106 and rests 152. Some other parts are made from other materials where a more hard-wearing material is required. For example, the skid plates 188 provided on the feet 106 are made from a harder-wearing material such as a solid plastic because they often slide across the ground as the hay steamer 100 is manoeuvred into position.

Care must be taken when attaching parts to a material like expanded foam as not all fixings will provide a secure connection. Specialist fixings are often required, which can be expensive. The figures show an advantageous arrangement to address this issue. The components (boiler 172, pump 174 and controller 176 and, optionally, the pipes 178 and wires 180) provided in the recess 166 on the underside 164 of the lower part 116 of the hay steamer 100 are not attached directly to the expanded foam, which would require many fastenings. Instead, the components 172-180 are mounted to a plastic tray 190 using conventional fixings like screws (not shown). The plastic tray 190 lines the recess 166 and is fixed to the underside 164 of the lower part 116 by relatively small number of specialist screws 192 that are specifically designed for fastening to foam. The screws 192 are provided with a deep thread to provide a secure connection to the foamed material. An example is the EPPsys D screw available from EJOT (https://www.ejot.com/). The plastic tray 190 also comprises ribs (not shown) around its edge to aid in securing the tray 192 to the lower part 116.

A person skilled in the art will appreciate that the above embodiments may be varied in many different respects without departing from the scope of the present invention that is defined by the appended claims.

In the above embodiment, a hay steamer 100 is described. However, the hay steamer 100 is not limited to steaming only hay. For example, the hay steamer 100 may be used for steaming any type of animal fodder such as straw, silage and haylage. The hay steamer 100 may also be used for growing plants, fruits and vegetables. For example, the hay steamer 100 may be used to pasteurise straw or other substrate when growing mushrooms. The hay steamer 100 may be used to steam silage in bales or in loose form.

The hay steamer 100 resembles a wheeled-trunk, and has a size suitable for containing a standard-sized hay bale 102. The hay steamer 100 can also be sized to hold half-sized and other sized bales, or loose hay.

As mentioned above, examples of the expanded polymer foam include expanded polypropylene foam and expanded polystyrene foam. However, other suitable types and combinations of expanded foams may also be used to form the hay steamer 100. In the above embodiment, the expanded foam has a density of 50-80 kg/m³ and a wall thickness of 60 mm. However, the expanded foam may have any suitable density and/or thickness that provides the required strength and insulation. The denser the expanded foam is, the thinner the walls may be.

It is not necessary for both the lower part 116 and the upper part 118 to be formed from the same expanded polymer foam. For example, different types/densities/wall thicknesses may be used for the lower part 116 and the upper part 118.

While the lower part 116 and the upper part 118 are described above as being joined by a hinge 120, other arrangements are possible. For example, the lower part 116 and the upper part 118 need not be secured to each other at all, and may just rest against each other such that the upper part 118 may be lifted from the lower part 116 when the hay steamer 100 is to be loaded and unloaded.

In the above embodiment, the seal 136 is provided on the upper part 118, but it may be provided on the lower part 116 instead. In alternative arrangements, the seal 136 is formed as a ridge of material so as to be integral to either the lower part 116 or the upper part 118. Also, rollers may be used in the place of wheels 104, or the wheels 104 may be omitted altogether. The capacity of the water tank 170 may also be varied.

1-20. (canceled)

21. An apparatus for steaming animal fodder comprising:
a body defining a chamber in which the animal fodder may be placed, the body comprising an upper part and a lower part configured to be placed together to form the chamber; and
a conduit configured to carry steam to an aperture configured to allow the steam to pass into the chamber;
wherein the chamber is accessed from the front of the apparatus and the wall of the body forming the front wall is provided by the upper part; and
wherein the lower part comprises a floor configured to receive the animal fodder and extends fully to the front of the apparatus.

22. The apparatus of claim 21, wherein the floor of the lower part is absent a lip at the front of the apparatus.

23. The apparatus of claim 21, wherein:
the walls of the body forming the side walls are formed by both the upper part and the lower part;
the side walls of the lower part increase in height from the front to the back; and
the side walls of the upper part decrease in height from the front to the back such that the upper part has a relatively high front wall and a relatively low back wall.

24. The apparatus of claim 21, wherein:
the aperture is provided in the floor; and
the floor comprises a raised section that forms a frame that extends around the aperture such that the frame is adapted to support a bale of animal fodder above the aperture in a spaced apart relationship.

25. The apparatus of claim 24, wherein the floor and the frame are integrally formed in the lower part.

26. The apparatus of claim 24, wherein the frame is discontinuous to leave a channel for water to drain from the area within the frame surrounding the aperture.

27. The apparatus of claim 26, wherein:
the floor is provided with a series of apertures configured to allow the steam to pass into the chamber; and
a single frame may extend around all apertures and may be provided with channels such that water may drain from the area surrounding each aperture.

28. The apparatus of claim 21, wherein the body is formed from an expanded polymer foam.

29. The apparatus of claim 28, wherein the expanded polymer foam is an expanded polypropylene foam or an expanded polystyrene foam.

30. The apparatus of claim 28, wherein the expanded polymer foam has a density of 50-80 kg/m³.

31. The apparatus of claim 28, wherein the body defining the chamber comprises a base provided by the lower part, a top provided by the upper part and walls provided by the lower part and/or the upper part, and wherein the base, the top and the walls are formed of the expanded polymer foam.

32. The apparatus of claim 31, wherein the expanded polymer foam of the base, the top and the walls is structural.

33. The apparatus of claim 31, wherein the upper part and the lower part are both unitary structures consisting of the expanded polymer foam.

34. The apparatus of claim 31, wherein the base, the top and the walls have a thickness of 60 mm.

35. The apparatus of claim 31, wherein the upper part and the lower part are joined by hinges to allow the upper part to be opened to provide access to the chamber, and wherein the upper part and the lower part comprise knuckles of the hinges formed from the expanded polymer foam.

36. The apparatus of claim 31, wherein:
the aperture is provided in the floor;
the floor comprises a raised section that forms a frame that extends around the aperture such that the frame is adapted to support a bale of animal fodder above the aperture in a spaced apart relationship; and
the floor and the frame is integrally formed in the lower part, and comprises the expanded polymer foam.

37. The apparatus of claim 21, further comprising;
a boiler operable to boil water and to generate the steam;
a pump operable to pump water to the boiler; and
a controller operable to control operation of the apparatus;
wherein the boiler, the pump and the controller are each mounted to a tray, and the tray is in turn mounted to the body of the apparatus using screws.

38. The apparatus of claim 37, wherein the body is formed from an expanded polymer foam, and wherein the screws are configured to work with the expanded polymer foam by having a shallow pitch and/or a wide thread.

39. The apparatus of claim 37, wherein the tray mounts in a recess provided in the underside of the lower part.

40. The apparatus of claim 21, comprising a hay steamer, and wherein the chamber has a size of at least 100 cm×40 cm×30 cm.
